(19) United States
(12) Patent Application Publication
(10) Pub. No.: US 2026/0160588 A1
(43) Pub. Date: Jun. 11, 2026

(54) LIVESTOCK WEIGHT ESTIMATION METHOD AND LIVESTOCK WEIGHT ESTIMATION SYSTEM

(71) Applicant: Eco-Pork co., ltd., Tokyo (JP)

(72) Inventors: Takeshi MAKINO, Tokyo (JP); Takashi KAMBAYASHI, Tokyo (JP)

(21) Appl. No.: 19/464,609

(22) Filed: Jan. 30, 2026

Related U.S. Application Data
(63) Continuation of application No. PCT/JP2024/029830, filed on Aug. 22, 2024.
(60) Provisional application No. 63/634,985, filed on Apr. 17, 2024.

(51) Int. Cl. G01G 17/08; G01G 9/00; G06Q 10/0832; G06V 40/10

(52) U.S. Cl. CPC G01G 17/08; G01G 9/00; G06V 40/103; G06Q 10/0832

(57) ABSTRACT

A livestock weight estimation system includes: a path along which livestock move in a single direction; one or more cameras that captures the livestock from above the path; and one or more computing devices, wherein the system further includes: an indication device that estimates the body weight of the livestock based on an image captured by the camera, determines, using weight class information stored in a storage device and sortable into three or more classes according to the body weight, weight class information corresponding to the estimated body weight of the livestock, and gives an instruction regarding the weight class information of the livestock according to the weight class information; or a marking device that applies, with paint, a physical mark relating to the weight class information onto a body surface of the livestock according to weight class information.

### CROSS-REFERENCE TO RELATED APPLICATIONS

The present application is a continuation application of International Application number PCT/JP2024/29830, filed on Aug. 22, 2024, which claims priority under 35 U.S.C § 119(a) to U.S. provisional Patent Application 63/634,985, filed on Apr. 17, 2024, contents of which are incorporated herein by reference in their entirety.

### Related Applications

This application claims priority and benefits of U.S. Provisional Application No. 63/634,985, filed Apr. 17, 2024. U.S. Provisional Application No. 63/634,985 is incorporated herein by reference in its entirety.

The present disclosure relates to a demand-driven livestock weight estimation method and a livestock weight estimation system. More particularly, the present disclosure relates to a method and system for automatically measuring the body weight of livestock and selecting an optimal shipping destination based on the body weight.

### BACKGROUND OF THE INVENTION

A method for estimating the body weight and body size of pigs using deep learning, particularly a convolutional neural network (CNN) (see U.S. Patent Application Publication No. 2023/0281265). For weight estimation, top-down images captured by a 2D color camera installed directly above a pig passage are used. The passage has one-way entry and exit, and only one pig can pass at a time, allowing an image of each individual pig to be obtained. However, measuring the body weight of pigs one by one makes it difficult to establish a shipping plan that maximizes profits in the pig farming industry.

### BRIEF SUMMARY OF THE INVENTION

Aspects and advantages of embodiments of the present disclosure will be set forth in part in the description which follows, or may be learned from the description, or may be learned through practice of the embodiments.

One exemplary embodiment of the present disclosure includes a livestock weight estimation method including: capturing, with one or more cameras, a group of livestock moving through a path from above the path; estimating, by one or more computing devices that include one or more processors, body weight of a livestock animal included in an image captured by the camera, identifying, by the one or more computing devices, the livestock animal included in the image captured by the camera; counting, by the one or more computing devices, the number of livestock included in the group of livestock by incrementing the count of livestock when the identified livestock animal passes through a region of interest; and generating and outputting, by the one or more computing devices, aggregate information based on the estimated body weight and the number of livestock, the aggregate information being used to create a shipping plan for the group of livestock.

One exemplary embodiment of the present disclosure includes a livestock weight estimation system including: one or more cameras that capture a group of livestock moving through a path from above the path; one or more computing devices that include one or more processors; and one or more computer-readable storage media that store instructions, wherein the one or more processors execute a process by executing the instructions, the process includes: estimating body weight of a livestock animal included in an image captured by the camera; identifying the livestock animal included in the image taken by the camera; counting the number of livestock included in the group of livestock by incrementing the count of livestock when the identified livestock animal passes through a region of interest; and generating and outputting aggregate information based on the estimated body weight and the number of livestock, the aggregate information being used to create a shipping plan for the group of livestock.

Aspects of the present disclosure thus enable the acquisition of body weight data for a plurality of livestock in a non-contact manner and allow on-site sorting for shipment.

It should be noted that any problems that are apparent to those skilled in the art from the embodiments, descriptions, drawings, or other content of the present disclosure, or that are characteristic of the present disclosure, may constitute problems to be solved by the divided invention in a divisional application based on the present disclosure.

### BRIEF DESCRIPTION OF THE DRAWINGS

FIG. 1 is a diagram illustrating an example of conventional livestock shipping status.

FIG. 2 is a schematic diagram for explaining a shippable livestock sorting system of the present disclosure.

FIG. 3 is a diagram illustrating a network configuration example of components constituting the system.

FIG. 4 is a diagram illustrating an example of a configuration that may be common to computing devices.

FIG. 5 shows an example of a still image and a moving image obtained by capturing with a camera.

FIG. 6 shows numerical ranges representing divisions of estimated body weights for classification into each class, and color data corresponding to the classes.

FIG. 7 is a flowchart showing a processing flow of a shippable livestock sorting method of the present disclosure.

FIG. 8 is a diagram illustrating an application example of the shippable livestock sorting system of the present disclosure.

FIG. 9 is a diagram illustrating another application example of the shippable livestock sorting system of the present disclosure.

FIG. 10 is a diagram illustrating another application example of the shippable livestock sorting system of the present disclosure.

FIG. 11 is a diagram showing an example of a marking device.

FIG. 12 is a diagram for explaining designation of an analysis area and detection of inclination of a walking surface.

FIG. 13 is a diagram for explaining correction of the estimated body weight based on the inclination of the walking surface.

FIG. 14 is an example of the body weights and head counts of a group of classified pigs.

FIG. 15 is an example of purchase prices of pigs for each class.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

In the present disclosure, livestock is described with pigs as an example; however, the technical scope of the present disclosure is not necessarily limited to pigs. Furthermore, while the terms “pigs” and “livestock” may be used interchangeably, which concept is intended should be understood appropriately from the context of the description. Regarding animal species other than pigs—such as cattle, goats, and sheep—namely, quadrupedal mammals whose body length (from the front end of the body [tip of the nose] to the rear end of the body [base of the tail]) can grow to approximately 1.0 m to 2.5 m, the technical implementation can be adapted through appropriate design modifications by those skilled in the art.

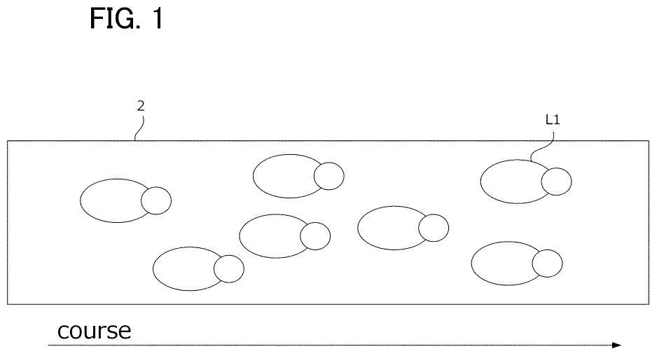

FIG. 1 is a diagram showing an example of conventional pig shipping status, presented as a reference. In this figure, the position and direction of movement of a livestock animal or a pig are schematically shown by using a circular head portion and an elliptical body portion, denoted as L1. The same applies to the subsequent figures. When a plurality of pigs are shipped from a piggery using a container or a trailer for shipping, the pigs walk from the left to the right in the drawing, passing through a path 2. Such a path 2 is a straight corridor (hallway or corridor) within the piggery that pigs pass through before shipment. When weight measurement is performed at the time of shipment, it is carried out by a physical contact weight scale, such as a load cell, installed at the exit of the path 2. Weighing pigs using the load cell is time-consuming and potentially dangerous, as the pigs must remain stationary.

Therefore, in the present disclosure, the body weight of each livestock animal is estimated in a non-contact manner by capturing an image of the livestock animal with a camera and analyzing the image obtained by capturing. However, for an optimal livestock shipping plan, estimating only the body weight of individual animals is insufficient.

As a common practice in raising pigs in the United States or other countries, there is a tendency to manage and raise a plurality of pigs together as a single group. Such a group may be referred to as a “lot”. In other words, pigs are usually not managed individually for body weight such that each pig is shipped once that particular pig reaches the appropriate body weight. In general, pigs in the same group or lot are of the same breed, but due to individual differences among livestock, both well-developed and poorly developed individuals usually arise. It is not realistic in terms of labor, equipment, and cost to make feeding adjustments to compensate for such individual differences, and it is difficult to strictly control variations in body weight that arise during the feeding process of individual pigs within the group. Therefore, when a group or lot composed of a plurality of pigs is considered to have reached an appropriate timing for shipment, the plurality of pigs are shipped at that timing. Alternatively, before shipment, a worker goes to a pigpen of the group or lot considered to have reached the appropriate timing, and performs the task of visually checking the size of the pigs one by one to determine their body weights and decide whether or not to ship them. Such work is labor-intensive and since the judgement is made visually, errors inevitably arise in the estimated body weights.

Further, in the United States or other countries, it is customary in the pig trade that, when purchasing a plurality of pigs, a specified number of pigs whose body weights fall within a predetermined body weight range are collectively traded. In this case, a set of pigs that fall within a more desirable body weight range may be traded at a higher price than a set of pigs that does not. There are multiple pig buyers in the market, each setting desirable body weight ranges with corresponding higher prices, and undesirable body weight ranges with corresponding lower prices. One example of a buyer who directly purchases pigs from producers or farms is a meat processor, generally referred to as a packer. The packer purchases pigs from farms, and performs subsequent slaughtering, carcass cutting, and processing. In recent years, oligopolization by major packers has been progressing in the United States. A contract may be concluded between a farm and a packer. Such a contract may specify, for example, the contract period, the supply volume and frequency during the contract period, the number of pigs that must be supplied per delivery, body weight standards, pricing, body weight premiums (where the purchase price per head increases if stricter body weight standards are met), and penalties per head for delayed delivery or failure to meet the body weight standards. Therefore, producers are required to strategically consider shipping plans, such as which group of pigs should be sold to which packer, in order to maximize the total sales amount. For such shipment planning, it is essential to grasp the body weight, the number of pigs, and weight distribution of each group or lot.

Therefore, simply being able to estimate the body weight of a livestock animal in a non-contact manner is not sufficient to conceive a concrete shipping plan. As described above, in actual livestock farming industry environments, it is not practical to wait until each pig is properly raised to the optimal body weight. A substantial number of livestock are shipped collectively at a timing convenient for the seller, i.e., the livestock producer, or the buyer. At that time, it is preferable to establish a shipping plan such that on-site personnel can recognize that: (i) the body weight can be immediately measured to allow grouping at least by weight class, (ii) proper classification into weight-based classes is performed, and (iii) information regarding the distribution of the number of livestock per weight class is provided; and that support for such a shipping plan can be performed using a computer system.

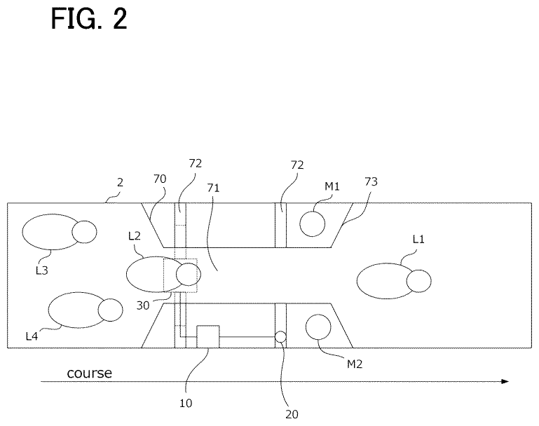

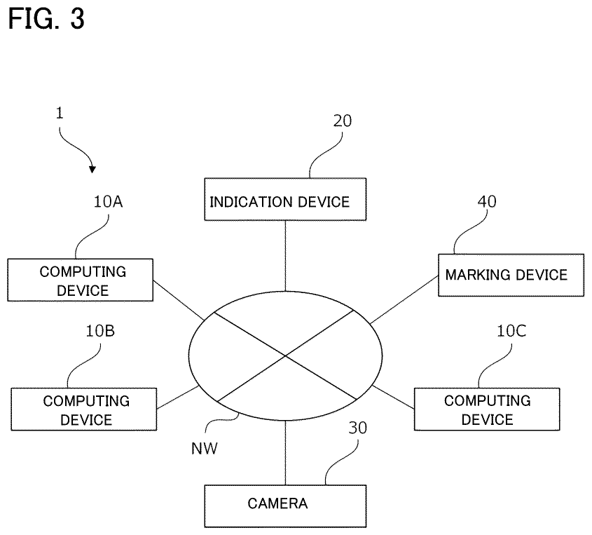

FIG. 2 is a schematic diagram for explaining an embodiment of a sorting system and a sorting method for new livestock shipping proposed by the present disclosure, and FIG. 3 is a diagram illustrating a configuration example of components constituting the system.

In this figure and the following figures, a path, which is a part of the space inside the piggery, allows a plurality of pigs to pass through in a single direction.

Within the space of the path 2, a temporary guidance structure 70 is installed, further narrowing the width of the path, such as an existing hallway or corridor, so that only a single livestock animal or a single pig can pass through, forming a space that may be referred to as a single-animal path 71. Furthermore, with the installation of the temporary guidance structure 70, between the temporary guidance structure 70 and the wall surface of the path 2, a storage space is formed, in which a control box (an example of one or a plurality of computing devices 10), an indication device 20 for indicating the distributed classes so that a human operator can recognize them visually and auditorily, and their power sources and the like can be installed; and a waiting booth where human operators M1 and M2 can stand and wait is also formed.

The temporary guidance structure 70 may be composed of a plurality of parts that are portable and can be assembled on site. The single-animal path 71 formed by temporary walls 73 of the temporary guidance structure 70 is designed with a width to the extent that one target livestock animal can pass through with a margin, but two livestock animals cannot pass simultaneously, thereby defining a width within that range. Such a single-animal path 71 may be designed, in principle, as a narrow rectangular shape with the temporary walls 73 extending in parallel in a straight line.

As an example of the configuration of the temporary guidance structure 70, various embodiments may be adopted, such as a pipe frame made of a light metal such as aluminum with a fabric cover made of nylon or the like, a high-strength plastic panel such as polycarbonate with joint parts, a wooden frame with plywood panels, or different combinations of these elements. By combining these elements, materials, and components, a portable fence that can be assembled on site can be formed. Using plastic material can also reduce noise.

It should be noted that the temporary guidance structure 70 does not need to be installed if a passage with a width capable of forming an appropriate single-animal path 71, or a facility designed in such a manner, already exists in a piggery or on site. In that case, the existing facility can be used as the guiding guide as is.

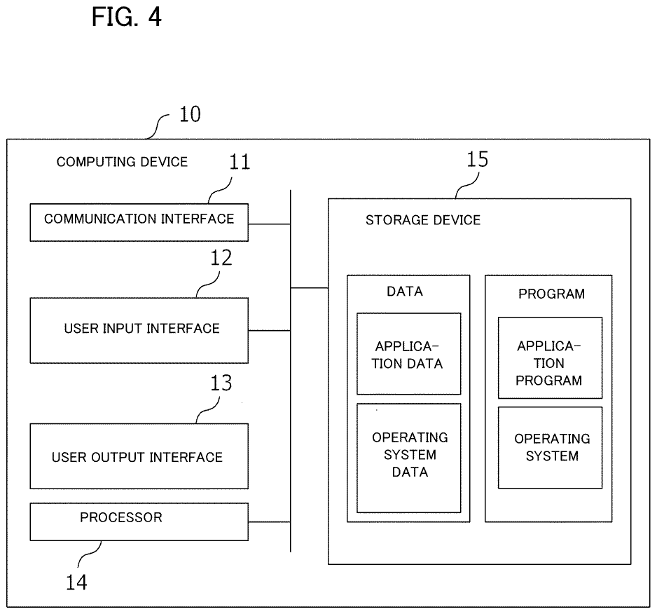

FIG. 3 is a diagram showing a network configuration example of a shippable livestock sorting system of the present disclosure. A shippable livestock sorting system 1 may include a first computing device 10A, a second computing device 10B, a third computing device 10C, an indication device 20, a camera 30, and a marking device 40, which are either connected to a network NW or directly connected via wired cables such as USB cables. The system may be a communication network capable of communicating with other electronic devices, supporting various types of electrical communication lines, including wired and wireless connections. That is, although in this figure all components appear to be connected via the network NW, each component may be connected individually to enable communication. In the network NW, the computing devices 10A, 10B, and 10C may be computing devices as described later with reference to FIG. 4. As will be described later, in a case where one computing device 10 has sufficient computing capability, other computing devices need not be provided. Depending on the computing power required, other computing devices located remotely may be provided.

FIG. 4 illustrates, as a computing device 10, one example of a configuration that may be common to computing devices 10A to 10C or other computing devices that may be located remotely and connected to computing devices 10A to 10C via the network NW. Typically, the computing device 10 includes a communication interface 11, a user input interface 12, a user output interface 13, a processor 14, and a storage device 15.

By causing the processor 14 to execute an application program based on application data stored in the storage device 15, the computing device 10 can execute and implement predetermined processing, operations, and control through cooperation between software and hardware resources. That is, the computing device 10 may include one or more computer-readable storage media storing instructions which, when executed by the one or more processors, cause the one or more processors to perform a plurality of operations. For example, the storage device 15 may store operating system data necessary for the computing device 10 to function as a general-purpose computer, and the operating system functions based on the operating system data.

Such a computing device 10 may be any type of electronic device such as a desktop computer, laptop computer, portable or mobile device, camera, mobile phone, smartphone, tablet computer, television, wearable device (such as display glasses or goggles, a head-mounted display (HMD), wristwatch, headset, or armbands), a virtual reality (VR) and/or augmented reality (AR) compatible device, or a personal digital assistant, for example.

The computing device 10 may be accessible by wired or wireless communication with a local database or other storage device similar to the storage device 15. The storage device 15 may be any processor-readable storage medium suitable for storing instructions to be executed by a processor, such as a random access memory (RAM), read-only memory (ROM), electrically erasable read-only memory (EEPROM), flash memory, or the like, provided accessible by a processor 230. The storage device 15 may be located apart from the processor 14 and/or integrated with the processor 14.

Any software may also be stored in any other suitable auxiliary storage device, secondary storage device, or temporary or non-transitory computer readable storage medium. In addition, any type of storage device (such as magnetic disks, optical disks, magnetic tapes, or other tangible media) may be regarded as a storage device.

The user input interface 12 and the user output interface 13 may be hardware devices that allow a user to input and output information in relation to the computing device 10 and/or other computing devices. The user may, for example, be a farm administrator, a worker, or a system administrator, a provider, or a person belonging to a management company. Specifically, input devices that may constitute the user input interface 12 may include a keyboard, mouse, one or more touch panel sensors, physical buttons arranged on the device according to function, a microphone, and the like. Similarly, output devices that may constitute the user output interface 13 may include a display, monitor, printer, data I/F (including Application Programming Interface (API)), speaker, and the like.

The communication interface 11 is capable of communicating with other electronic devices corresponding to various types of telecommunication lines such as wired and wireless connections. For example, communication can be performed via a wide-area network connection though a fiber-optic network or a digital telephone line, a local wireless connection, short-range wireless communication, or a satellite-based positioning system.

The processor 14 may be one or more of any type of computer processing element, such as an integrated circuit or controller that executes processor operations via a central processing unit (CPU), graphics processing unit (GPU), tensor processing unit (TPU), neural processing unit (NPU), digital signal processor (DSP), field-programmable gate array (FPGA), application-specific integrated circuit (ASIC), or the like. For example, the processor 14 may be one or more single-core processors. Alternatively, the processor 14 may be one or more multi-core processors having multiple independent processing units. The processor 14 may also include register memory for temporarily storing instructions being executed and associated data, as well as cache memory for temporarily storing recently used instructions and data. When processing is performed using a plurality of processors, it is not necessary for the same processor to perform all of the processing.

The computer system may employ a cluster configuration in which a plurality of computers are grouped and connected via a network. In such a case, the same computer system may be installed in multiple locations. The specific locations and connection methods of these computing devices are not important, and they may be located in a foreign country different from the country in which the user and farm are located. Here, the term “farm” refers to a place where livestock are actually being raised. Such a group of computing devices may be treated as one cloud computing resource that is distributed across various data centers.

When a mobile terminal such as a smartphone used by a user has sufficient processing capability, the mobile terminal may be used as a standalone small computer to perform all calculational processing. In addition, it is also possible for the mobile terminal to handle part of the computational processing as a part of a “cluster” or an “edge computing” environment formed by grouping together with multiple other computers.

As an example, the first computing device 10A may be a control box installed inside the temporary guidance structure 70, the second computing device 10B may be a smartphone or a tablet terminal operated by on-site personnel, and the third computing device 10C may be a server computer installed at a remote location. That is, each computing device may function as a terminal that shares and processes operations in the present disclosure. In the above example, the control box of the first computing device 10A includes at least one of a processing device such as the graphics processing unit (GPU), tensor processing unit (TPU), and neural processing unit (NPU). By having a predetermined or greater image processing capability and video memory capability, the computing device can function as an edge computing device capable of performing local image analysis without relying on the computational resources of other computing devices via a network. This is particularly useful in environments, such as farms, where communication may be unstable. In this case, the second computing device 10B may be a terminal that allows the user to receive information or to support instructions to the extent required, and the third computing device 10C may serve to receive information to be stored at that point. The first computing device 10A may be responsible for the primary computational resources for substantial on-site information processing.

The camera 30 is installed to capture a livestock animal from above the path 2 and estimate the body weight of the livestock animal from the captured image.

The minimum output expected by the camera 30 may be a two-dimensional image captured from an overhead viewpoint. Using a two-dimensional monochrome or color image taken from a viewpoint directly above the livestock animal, the contour of the livestock animal can be detected through image analysis to estimate sizes such as body length or body width, from which the body weight can be estimated. Any algorithm may be used to estimate the body weight as described below.

More preferably, the camera 30 is a stereo camera capable of capturing a target object from two viewpoints with parallax, and obtaining an image that includes the distance to the target object based on the time it takes for emitted light, such as ToF (Time of Flight), to reflect off the surface of the target object and return to the center. Such an output is acquired as depth map or depth information, allowing the construction of a three-dimensional representation of the livestock animal. When the depth map is acquired, an infrared projector mounted on the camera 30 may be used to project structured light, such as an infrared dot pattern or a grid pattern, onto the environment, and the projected image may be analyzed to improve the measurement accuracy of the depth map. In addition, an inertial measurement unit such as an IMU may be mounted on the camera 30, and the tilt of the camera 30 can be detected using the IMU's accelerometer and gyroscope sensors. The tilt detected by the IMU may be used to correct the position of the camera 30, or may also be used to correct the tilt of the image or the tilt of the depth map. This tilt information can be used to correct the three-dimensional model of the livestock animal, contributing to improve accuracy in weight estimation. Further, as will be described later, depth information may also be used to improve the accuracy of counting the number of livestock.

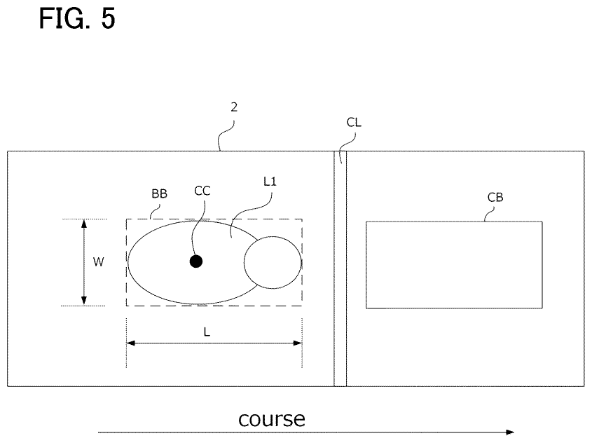

FIG. 5 shows an example of a still image or a moving image of one livestock animal in a top-down view from directly above, which is obtained by capturing with the camera 30. For estimating the body weight of a pig, for example, a weight estimation model may be used, which estimates Weight (body weight) using the pig's length L (mm) and width W (mm) derived from a moving image and a still image included in the moving image as parameters. The weight estimation model is a trained model in which the relationship between the length L (mm), the width W (mm), and the Weight (body weight) is learned in advance using machine learning, such as deep learning. For training such a model, for example, a neural network is constructed in which the length L (mm) and the width W (mm) are used as input features and the Weight (body weight) is output. Learning is performed for the constructed NN using the trained data in which the length L (mm) and the width W (mm) are paired with the Weight (body weight), so that the accuracy of weight estimation is improved, thereby obtaining a trained model. In addition, in order to improve weight estimation accuracy, a trained model may be used that incorporates, as additional features, the distance between key points estimated on an image, the pig's moving speed (distance moved per unit time), a value obtained by statistically processing depth information obtained from the depth map, and the like. The weight estimation may be performed multiple times for one pig, and the estimated body weights may be statistically processed to provide a representative value.

In addition, a weight calculation formula for the pig may be one that estimates the body weight by inputting parameters serving as explanatory variables, such as the pig's width, length, and height using, for example, a regression formula based on multivariate analysis. One non-limiting example of such parameters is the length L (mm) and the width W (mm). For example, assuming that the body weight is estimated by using a multiple regression equation such as Weight (body weight)=αL+βW+γ (α and β are coefficients, and γ is a constant term), L and W may represent the length L (mm) and the width W (mm)).

In addition, as a unit of body weight, not only kg but also pounds (lb) and jin (a Chinese unit of weight, where one jin corresponds to 500 grams (0.5 kilograms or approximately 1.1 pounds) may be used. Furthermore, a carcass weight estimated based on the estimated body weight may be used. The carcass weight can be estimated, for example, by multiplying the estimated body weight by a predetermined coefficient.

The above is merely an example, and for weight estimation using images, any configuration combining the above-described elements can be implemented.

Furthermore, the shippable livestock sorting system 1 may be configured to be capable of counting the number of livestock using a moving image captured by the camera 30. In FIG. 5, it is assumed that a livestock animal L1 is moving from left to right. In this case, for example, when a reference point such as a center coordinate CC (which may be the centroid of the bounding box, the centroid of a mask region, or an estimated key point of the head) crosses a counting line CL that can be set as a region of interest in the moving image or an image, it is possible to count one livestock animal as being present. That is, specific points or coordinates representing the center or centroid positions of a plurality of livestock animals' bodies are tracked for each frame, and each time they cross the counting line CL, the head count is incremented, thereby enabling the total number of livestock to be counted. The counting line CL is merely one example of the region of interest, and the counting region does not need to be linear. In addition, as a non-limiting example, the number of pigs passing through the path 2 may be counted by sequentially acquiring information of the pigs using the depth map acquired via the camera 30, verifying whether or not the same pig is observed across consecutive images (depth maps) using techniques such as the degree of overlap of pig regions (IoU: Intersection over Union) based on coordinate information on the screen, and performing counting while the application is running. The advantage of using a depth map is that, in a passage where pigs move and sufficient light is not available, the pigs do not emit light themselves, so object identification using only RGB information from a visible-light camera, based on features such as the pig's contour or shape, is difficult in the dark. By using a depth map, which does not depend on RGB information or visible light, counting is possible in any environment. The difference from the counting line CL described above is that, without establishing a specific line, the total number of pigs passing through the entire image including the path 2 can be counted. As another example, in the method described above, the number of times a weight value is calculated through weight estimation, or in the case where multiple weight estimations are performed for a single pig, the number of times a representative value is calculated through statistical processing may be treated as the number of livestock. That is, if there is no overlap among the livestock to be counted, the number of weight estimations performed can be treated as the head count.

The region of interest for counting livestock is not limited to the counting line CL, and may be a region of interest designated at any position or location. For example, it is possible to count the number of livestock in units of lots, reset the count, and then count the number of livestock in the next lot. Simply by counting all livestock whose bodies partially pass through the region of interest between the start and end of measurement, it is possible to count the livestock belonging to the lot. In addition, in order to prevent the occurrence of an error in counting, the following measures can be taken. For example, as shown in FIG. 5, a count box CB having the size of a pig may be set as the region of interest, and the count box CB may be compared with a bounding box BB recognized as a pig. When the bounding box BB recognized as a pig passes through the count box CB, one pig may be counted as having passed. Other counting methods will be described later.

The indication device 20 is installed so that a human operator on-site can visually or auditorily identify that a livestock animal passing through the single-animal path 71 has been classified into one of the weight classes on the basis of predetermined criteria.

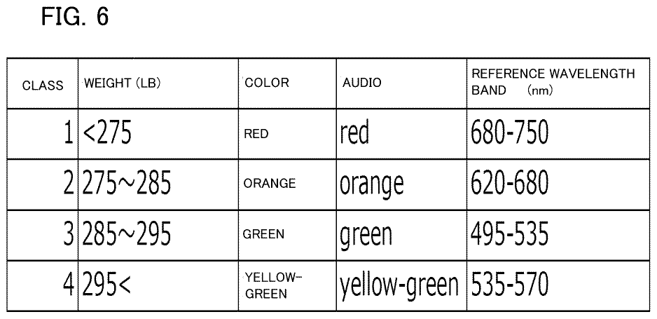

FIG. 6 shows an example of data defining numerical ranges representing divisions of estimated body weights for assignment to each class, the corresponding classes, and the correspondences between colors and audio information corresponding to the classes. It is preferable that the classes be divided into at least three or more types. This is because if three or more classes exist, there will be classes within the range bounded by the upper limit value and the lower limit value. In this example, for instance, less than 275 pounds is set as class 1. In class 1, no lower limit value is defined. In class 2, pigs with a body weight of 275 pounds or more and less than 285 pounds correspond. In class 3, pigs with a body weight of 285 pounds or more and less than 295 pounds correspond. In class 4, pigs with a body weight of 295 pounds or more correspond. Such a class setting is also possible with four or more classes. The numerical range for each class, for example, in the example of FIG. 6, a range of 10 pounds, is defined, but does not need to be uniform. As will be described later, a weight range corresponding to the premium price can be set. For example, class 1 may be classified into less than 275 pounds, class 2 may be classified into greater than or equal to 275 pounds and less than 280 pounds, class 3 may be classified into greater than or equal to 280 pounds and less than 290 pounds as a weight range corresponding to a premium price, class 4 may be classified into greater than or equal to 290 pounds and less than 295 pounds, and class 5 may be classified into greater than or equal to 295 pounds.

For the colors corresponding to the classes, wavelength information of light representing the colors is described for reference. Furthermore, audio data for providing a notification of the color is defined. As a result, classification is performed based on the estimated weight and the weight classification of the data, and a notification of the classification is provided. Such data may be stored in any of the storage devices constituting the system. Examples of data are not limited to this, and graph databases may be employed as relational or non-relational databases, allowing relationships to be referenced as represented by nodes, edges, and properties.

The indication device 20 is, for example, an indicator or a projector device having a light source such as an LED or a lamp, and can emit light of a predetermined color onto the single-animal path 71. What kind of color should be emitted will be described later. Alternatively, the indication device 20 may be an image display device such as a liquid crystal display or an OLED display, and in that case, the indication device 20 may display light of a predetermined color, or may be installed at a location where the indication device 20 is directly visible to the user. More simply, the indication device 20 may be a lamp that emits predetermined light, a stack light, or a signal tower. In addition, the indication device 20 may be a speaker or a sound generating device, and may provide a notification to a person at the site through hearing by generating a sound corresponding to a color.

When classification is indicated by color, the color used is one that livestock cannot visually distinguish. For example, pigs are said to be red-green color blind, meaning they cannot distinguish between red and green. By using such colors for the display, even if the signals are switched by color on-site, it is possible to guide the pigs without being frightened.

A light emitting portion, such as an LED lamp of the indication device 20 may be installed outside the field of view of pigs during their normal walking. For example, assuming that the eye height of an adult pig during normal walking is approximately the same as the shoulder height, i.e., 70 cm to 90 cm, the light emitting portion may be installed at a height of 1 m or more above the walking surface.

The marking device 40 is installed for the same purpose as the indication device 20, and is used to apply a mark of a predetermined color to the body surface of a livestock animal. Specifically, it may be an ink roller, with a predetermined color of ink filled around the roller. When the roller descends, it contacts the body surface, such as the back of a livestock animal, and can apply a mark of the predetermined color to the livestock animal passing through the single-animal path 71. Unlike a notification by the indication device 20, which is made only at the moment a livestock animal passes, such a mark can remain on the livestock animal and continue to be visually recognized by humans even after the notification has ended. An example of the use of the marking device 40 will be described later.

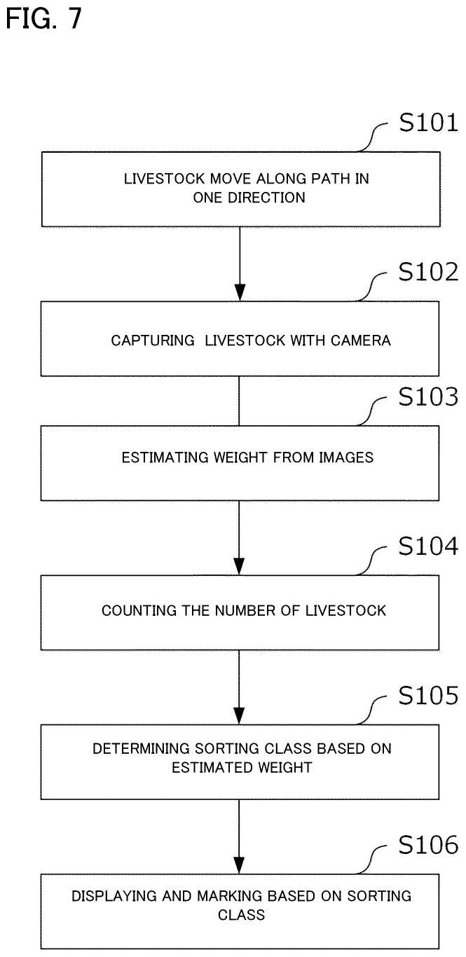

Returning to FIG. 2 again, the flow of sorting processing using the shippable livestock sorting system of the present disclosure using the above configuration will be described. FIG. 7 is a flowchart showing a processing flow of the shippable livestock sorting method according to the present disclosure.

In the information processing described below, for example, for calculations of weight estimation, the first computing device 10A may be selected as having the necessary computational resources as an edge computer, as described above. If the computational capability is sufficient, a single computing device may be used, and if the computational capability is insufficient, computational resources of a plurality of computing devices connected via the network NW may be used. In addition, the first computing device 10A is not limited to use as computational resources, and may also serve as data storage. In the following description, all or part of the processing executed by the first computing device 10A may be performed by the third computing device 10C.

The matters described below are executed by running an application program, based on application data stored in the storage device 15 of any of the above-mentioned computing devices, on the processor 14, whereby operations corresponding to instructions are performed, and functions are realized through the cooperation of software and hardware resources.

In response to an instruction from a user via the user input interface 12, when a weight measurement start signal for shippable livestock sorting is transmitted from the second computing device 10B, the first computing device 10A transmits a capture instruction signal to the camera 30 so that the camera captures a livestock animal passing through the single-animal path 71. The user who transmits such instructions may be, for example, a worker employed at the farm or an operator who operates equipment under farm contract, and may perform weight measurement of the livestock regularly as part of their daily routine. As a more specific example, although not illustrated, the second computing device 10B may be configured such that, in response to the user pressing a measurement start button displayed on a screen of the second computing device 10B having a touch panel, the measurement start signal is transmitted.

After entering the measurement start state, in step S101, the livestock are guided to move in a single direction along the path. It is preferable that on-site personnel guide the livestock so that each livestock animal passes through the single-animal path 71 one by one at a predetermined speed.

Next, in step S102, one or more cameras 30 captures the livestock from above the path 2. This allows acquisition of a top-down image of each livestock animal whose weight is to be estimated.

Next, in step S103, the weight of each livestock animal is estimated by the first computing device 10A using the image captured by the camera 30. The first computing device 10A then outputs the estimated weight of the livestock animal being estimated.

The intermediate processing illustrated here may be as follows. The first computing device 10A uses, for example, an image acquired from the camera 30 to independently extract a region where a livestock animal is present from pixels, a point cloud, or a depth map included in the image. In brief, the first computing device 10A identifies the livestock animal included in the image. A set of coordinates of pixels within a region in which the livestock animal is present may be referred to as a livestock region coordinate group. The first computing device 10A may extract the region in which the livestock animal is present from the acquired depth map or depth information, and may use the extracted region as a mask. From the mask, the first computing device 10A can obtain a mask centroid. The first computing device 10A may track the mask centroid as the center coordinates of the livestock animal.

When identifying the livestock region coordinate group, the mask, or the like using an image, it is generally performed using machine learning or deep learning techniques such as feature extraction and classification. Even a general object detection model has the ability to recognize and segment the shape of an object based on visual features such as contours, textures, and forms of the object. Furthermore, to avoid misrecognition, the first computing device 10A may perform additional learning or reinforcement learning based on a dataset containing images of livestock. In addition, the first computing device 10A may identify pigs using pose models or the like specialized for quadrupeds, not limited to livestock.

By such image analysis, a provisional ID may be assigned to a livestock animal (or to an image of the livestock animal, a point cloud of the livestock animal, a three-dimensional image of the livestock animal, a mask of the livestock animal, a mask centroid of the livestock animal, or other coordinates of the livestock animal being tracked). In farms that utilize ICT, pigs being raised may be managed using individual IDs. Regarding such individual IDs of pigs, there are technologies that perform individual authentication, for example, using a two-dimensional code or a tag attached to an ear tag. However, the provisional ID referred to herein is a temporary ID that differs from such individual IDs. The reason is that identifying individual IDs requires more advanced technology, which increases costs, and, in the present disclosure, it is sufficient merely to detect a livestock animal walking along a restricted path. Furthermore, since livestock such as pigs move quickly, it is sometimes difficult to track them when they move out of the camera's field of view. When a pig reappears within the image frame, this will result in a new ID being assigned; therefore, using provisional IDs allows for more efficient operation. In this manner, when a pig identified through the image analysis is assigned a provisional ID, the identified pig with the provisional ID can be continuously and automatically tracked. Various methods for improving the weight estimation accuracy of the livestock will be described later. The technique described below is utilized in the weight estimation step described above.

Here, the first computing device 10A can also count the number of livestock by detecting whether or not the center coordinates, centroid coordinates, or predetermined feature points indicating a part of the body of the identified livestock animal to which the provisional ID has been assigned pass a count line set on the image. The first computing device 10A may perform counting of the number of livestock in step S104. Regarding the counting (count) of the number of livestock, the first computing device 10A may perform processing to increment the number of livestock when the mask centroid being tracked passes through the region of interest. In addition, information indicating the mask centroid may include height information obtained from depth information. If the mask centroid is at or below a predetermined height or a preset height set in advance, the first computing device 10A may perform processing in which the object is not counted toward the livestock total. The use of the mask centroid can suppress apparent fluctuations caused by the movement of livestock. Compared to object detection using a rectangular bounding box surrounding the livestock region coordinate group, this method has an advantage of improving tracking stability because it is not dependent on changes in the outer shape of the rectangle. In this manner, filtering of objects to be counted may be performed using the height information, and a test at the predetermined height may be conducted in advance to ensure accurate counting. Regarding height-based filtering, the first computing device 10A may provide flexible configuration methods such as manual input of a specified value, selection of a preset, or automatic setting based on prior measurements. As a result, the first computing device 10A can perform optimal detection according to various environments and target livestock. In addition, as a method of filtering using the height of livestock, a method may be adapted in which a difference is taken between the height of a floor surface, obtained in a floor-surface measurement described later, and the body height, center, or centroid of a livestock animal. However, for quadrupedal livestock, the lower direction of the livestock region becomes infinite in the depth information. Thus, although it is possible to fix the ground position and take the difference as described above, the space other than the legs cannot be captured. Therefore, there is an advantage in adopting the mask centroid.

Next, in step S105, the first computing device 10A determines and outputs the weight class information of each livestock animal corresponding to the estimated weight information, using weight class information stored in the storage device and estimated weight information.

Next, in step S106, the indication device 20 displays the weight class information of the livestock according to the weight class information. Alternatively, the marking device 40 may mark the body surface of the livestock with an indication corresponding to the weight class information.

As a result, the on-site personnel can easily understand which weight class the livestock animal whose weight has been estimated belongs to, and can immediately and physically sort the livestock animal L1 on site after it passes through the single-animal path 71. For example, pigs may be reorganized into shipment groups by weight bands that are color-coded based on weight thresholds, depending on the purpose. Alternatively, even when the same individuals that constitute a lot are retained within that lot, a lot having an appropriate weight distribution can be sold to a suitable buyer.

The first computing device 10A may generate aggregate information for any group of pigs using the estimated weight of each pig and the number of pigs. One example of the aggregate information is a histogram of head count and body weight, for example. This aggregate information is used to create a shipping plan, which will be described later. The aggregate information may also be output in a predetermined data format via the user output interface 13.

This concludes the description of the basic processing flow of the shippable livestock sorting method of the present disclosure. Hereinafter, an application of the shippable livestock sorting method of the present disclosure will be described.

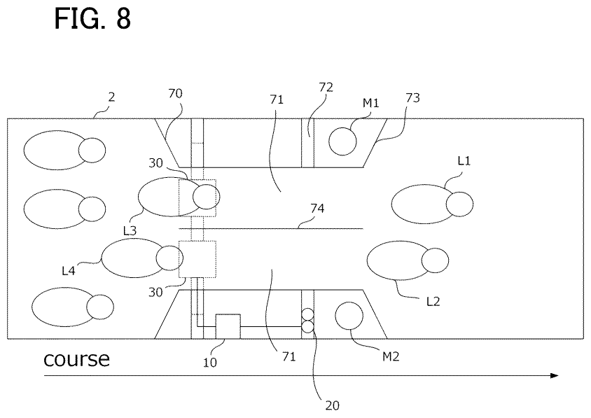

FIG. 8 is a diagram illustrating an application example of the shippable livestock sorting system of the present disclosure. In this figure, since the basic configuration is the same as that shown in FIG. 2, the description of identical components is omitted. A characteristic feature in FIG. 8 is a plurality of single-animal paths 71 and 71 formed by partition walls 74.

Even when the acquired image captures a plurality of livestock animals, the camera 30 can estimate the weights of the plurality of livestock animals simultaneously by using an object-differentiation technique such as instance segmentation. However, in some cases, it is preferable that the single-animal path 71 be configured with a plurality of lanes in order to improve the accuracy of weight estimation, particularly for heavier livestock, and to facilitate on-site guidance and safety of the livestock. By measuring the livestock animals one by one, the accuracy of weight estimation is improved. In addition, individual computing resources, such as edge computers, can be concentrated on the estimation of a single livestock animal. Furthermore, considering the display of the indication device 20, which indicates to which class a livestock animal whose weight has been estimated belongs, and the speed of human perception in identifying that display, such an organized arrangement may be preferable. Moreover, increasing the number of lanes also provides the effect of improving throughput.

In this case, a plurality of indicators constituting the indication device 20 are installed, and it is possible to display images captured by the camera 30 of each lane, the body weights estimated based on the images, and the colors corresponding to the classes associated with the estimated weights.

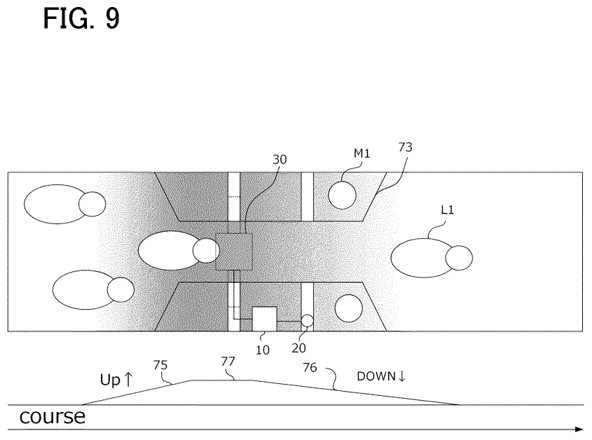

FIG. 9 is a diagram illustrating still another application example of the shippable livestock sorting system of the present disclosure. In this figure, since the basic configuration is the same as that shown in FIG. 2, the description of the identical component is omitted. A characteristic feature in FIG. 9 is a slope on the single-animal path 71, which is formed by an ascending slope 75 and a descending slope 76.

Pigs tolerate uphill slopes well but exhibit difficulty on downhill slopes, and this behavioral tendency is exploited. Specifically, the ascending slope 75 is installed in front of the entrance of the single-animal path 71, and the descending slope 76 is installed at the exit. Between the ascending slope 75 and the descending slope 76, a flat floor 77 of an appropriate length may be provided, or it may be omitted. The angles between the ascending slope 75 and the floor surface prior to installation and between the descending slope 76 and the floor surface prior to installation may be set between greater than or equal to 2° and less than 15°. Angles exceeding this range may cause pigs to become frightened or to stumble, thereby increasing the risk of accidents. As a result, pigs that have easily entered the single-animal path 71 from the uphill slope tend to hesitate before proceeding down the downhill slope, thereby remaining in the path longer. This ensures sufficient time to capture images for weight estimation and also restrict the pigs' activity within the single-animal path 71. Furthermore, different slope angles may be adopted for the ascending slope 75 and the descending slope 76. For example, by increasing the slope angle of the descending slope 76 relative to the ascending slope 75 causes pigs to hesitate on the exit side, resulting in a delay in the flow of the line. Conversely, by making the slope angle of the descending slope 76 smaller than that of the ascending slope 75, it is also possible to control the pigs' traveling speed. Additionally, the ascending slope 75 and the descending slope 76 may be provided with anti-slip treatment. For example, grooves may be formed on the surface of the material, or a material such as rubber capable of preventing slipping may be used. This improves the accuracy of weight estimation and further ensures the safety of the operator.

Such an ascending slope 75 and descending slope 76 may also be employed in configurations where the single-animal path 71 is constituted by a plurality of lanes arranged in parallel. By providing the plurality of lanes, the decrease in throughput caused by the slopes can be compensated for, resulting in a synergistic effect from the combination.

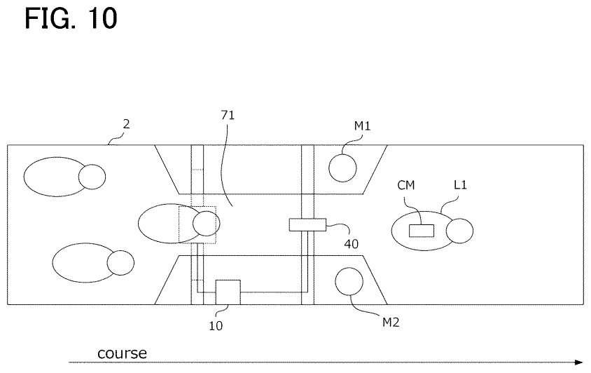

FIG. 10 is a diagram illustrating still another application example of the shippable livestock sorting system of the present disclosure. In this figure, since the basic configuration is the same as that shown in FIG. 2, the description of the identical component is omitted. A characteristic feature in FIG. 10 is the marking device 40, which is installed in place of, or in addition to, the indication device 20.

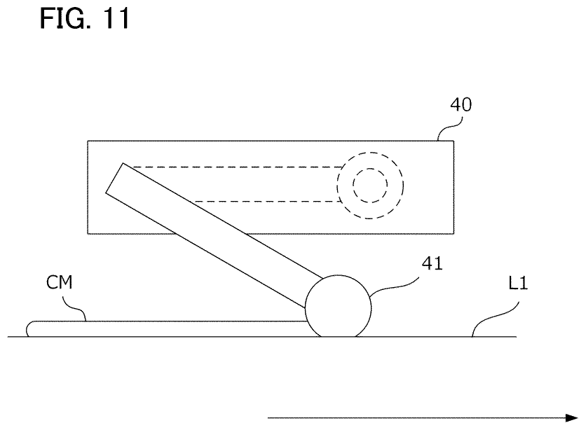

FIG. 11 is a diagram showing an example of a marking device. The marking device 40 is, for example, an ink applying device such as an ink roller. The roller 41 filled with ink is lowered in response to an instruction signal from the computing device configuring the system 1, and can apply ink by coming into contact with a body surface such as the back of the livestock animal L1. Alternatively, a sensor, such as an infrared sensor, which detects the passage of a livestock animal below may be provided, and the roller 41 of a predetermined color may be lowered upon detection of the passage of the livestock animal. Alternatively, on-site personnel may manually operate the roller 41 to apply ink by referring to the color indicated by the indication device 20.

When the single-animal paths 71 are arranged in parallel in a plurality of lanes, the marking device 40 may be provided for each of the single-animal paths 71. In addition, a plurality of marking devices 40 may be arranged in series along the traveling direction in each of the single-animal paths 71. With this arrangement, a greater number of color-coded markings can be applied. Furthermore, when a slope is provided, the marking device 40 may be disposed above a position corresponding to the flat portion located immediately before the downhill slope. In this case, a synergistic effect is obtained in that a marking can be applied while the pig is stationary.

The ink for marking may be, for example, a non-toxic, animal-safe livestock marker paint. A method using ink is non-invasive and therefore preferable from the perspective of animal welfare. By using the ink roller, it is not necessary to consider failures due to nozzle clogging in sprays or the generation of harmful gases. Thus, even after the display on the indication device 20 has ended, the markings remain on the body surface of the livestock animal, allowing on-site personnel to identify the class to which each livestock animal has been classified.

Next, as an effort to improve the accuracy of weight estimation using images, correction of tilt will also be described. As described above, when an inertial measurement unit such as an IMU is mounted on the camera 30, the tilt of the camera can be detected and calibrated, thereby correcting the tilt of the camera itself. However, the horizontalness of the surface on which the pigs walk cannot be detected by the IMU of the camera. Therefore, as an application example, a tilt correction function that is possible when the camera 30 is a device capable of acquiring distance images, such as a stereo camera, will be described.

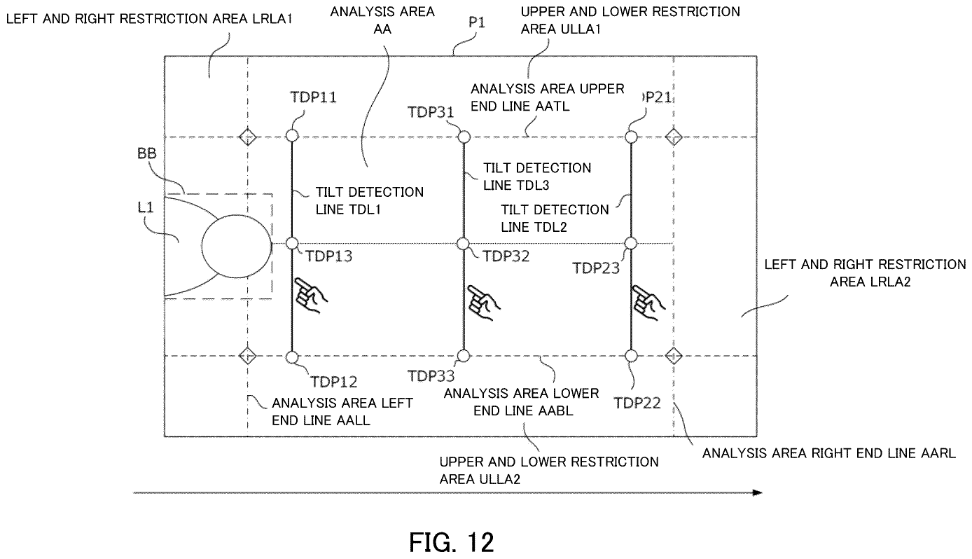

When the camera 30 is a device capable of acquiring distance images, such as a stereo camera, a ToF camera, a structured illumination type three-dimensional camera, a LiDAR scanner, or a three-dimensional point cloud scanner, the camera 30 can acquire the distance from the camera 30 to a subject at a point designated on a top-down image. FIG. 12 illustrates a case where the computing device 10A or the computing device 10C includes a touch panel display, and by means of that touch panel display, displays an operable screen P1. Such an operable screen P1 may be used, for example, as a preparatory step in in the computing device 10A or 10C before performing weight estimation. In the example of the operable screen P1 in FIG. 12, the livestock animal L1 enters the path from the left side and exits on the right side. Therefore, the left side corresponds to the entrance, and the right side corresponds to the exit.

By performing an operation on the operable screen P1, the user can designate an image region to be used for weight estimation across the entire screen. The designating method may be, for example, designating an area or a point by touching the touch panel with a finger, or designating an area or a point by moving a pointer with a mouse. Through these operations, an analysis area upper end line AATL, an analysis area lower end line AABL, an analysis area right end line AARL, and an analysis area left end line AALL are designated, and an area enclosed by these lines is defined as an analysis area AA. In this way, the subjects for weight estimation can be restricted to only livestock individuals captured within the analysis area AA. Livestock individuals that are imaged in areas outside these lines, specifically left and right restriction areas LRLA1 and LRLA2 and upper and lower restriction aeras ULLA1 and ULLA2, are excluded from weight estimation. One reason for providing such a restriction is that, for example, in a piggery, when attempting to perform weight estimation using a passage between pigpens, a pigpen facing the passage may appear at the top and bottom of the captured image, potentially including a pig that is not the target of weight estimation. Furthermore, by imposing such a restriction, an unnecessary image can generally be excluded, thereby improving the accuracy of estimation. Note that methods and designs for designating an analysis restriction area are not limited to the above examples, and may be, for example, a circular shape, an elliptical shape, or a trapezoidal shape. In addition, as a method for filtering the pigs that are not subjects for weight estimation, a depth camera may acquire depth information in a predefined region of interest. By explicitly designating an observation range along the path using this region of interest, livestock outside the path that are not subject to measurement can be excluded. Furthermore, a region of interest may also be set in the height direction, enabling three-dimensional filtering.

After the analysis area has been designated as described above, the tilt of the walking surface of pigs within the analysis area AA can be estimated by having the user designate at least two points within the analysis area AA on the operable screen P1. For example, in FIG. 12, by designating one point on the entrance side in the analysis area AA, a tilt detection line TDL1 is generated. This is because if the analysis area AA is considered as a set of pixels forming an XY plane, a straight line can be generated that passes through the designated point and shares the same X coordinate. Accordingly, tilt detection points TDP11, TDP12, and TDP13 can be automatically set. The inclination detection point TDP11 is an intersection of the tilt detection line TDL1 and the analysis area upper end line AATL, the tilt detection point TDP12 is an intersection between the tilt detection line TDL1 and the analysis area lower end line AABL, and the tilt detection point TDP13 is the midpoint between the tilt detection point TDP11 and the tilt detection point TDP12 on the tilt detection line TDL1. Similarly, by designating one point on the exit side, the tilt detection line TDL2 and the tilt detection points TDP21, TDP22, and TDP23 are automatically generated. Furthermore, an arbitrary point may be designated near the center to automatically generate the tilt detection line TDL3 and the tilt detection points TDP31, TDP32, and TDP33.

In the camera 30 that is a device capable of acquiring distance images, such as the stereo camera, the ToF camera, the structured illumination type three-dimensional camera, the LiDAR scanner, or the three-dimensional point group scanner, the distance between the camera 30 and the walking surface at each of these tilt detection points can be acquired. The distance may be acquired as a length representing the distance to each tilt detection point, or may be acquired as the height of each tilt detection point. Here, the heights of the respective tilt detection points are considered.

The tilt of the walking surface or the inclined plane can be estimated from the heights of the respective tilt detection points. When estimating a plane, at the minimum, three points are sufficient for estimation. Accordingly, if the heights of four or more tilt detection points—corresponding to at least two tilt detection lines and their respective upper and lower points—can be acquired, a simple plane estimation can be performed. When three points are used, the plane can be estimated by a method of deriving a plane equation using vectors or by using simultaneous equations. When four or more points are used, the plane can be estimated using methods such as the least squares method, RANSAC, SVD, or TLS. Once the plane has been obtained, the normal vector of the plane can be used as the tilt.

In the example of FIG. 12, the walking surface can be estimated using, for example, nine tilt detection points. It is preferable that these nine points are distributed so as to serve as representative points of the respective divided regions when the analysis area AA is divided into nine regions as evenly as possible. By using nine points as described above, when estimating a simple plane, the influence of outliers can be eliminated, allowing a more reliable estimation of the tilt of the walking surface. Alternatively, the nine points may be used to estimate a composite surface. For example, by connecting the nine points, a walking surface composed of four planes can be generated. The overall walking surface may be estimated in such a way that it forms a composite surface composed of these four planes.

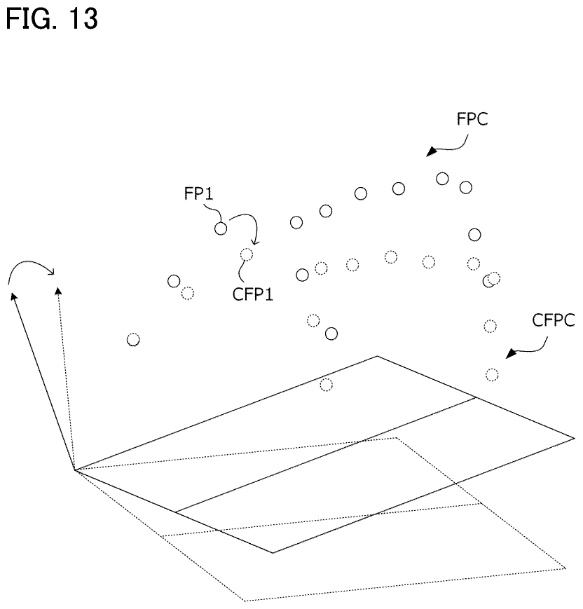

Using the tilt of the walking surface estimated in this manner, the first computing device 10A can correct the estimated body weight. FIG. 13 is a diagram for explaining correction of the estimated body weight based on the tilt of the walking surface. For example, from an image of a pig captured by the camera 30, a feature point group FPC including a plurality of feature points FP1 and the like in a three-dimensional space having height information can be extracted. Such a feature point group represents three-dimensional position information of main parts of the pig, such as the head, back, and tail, which can be obtained from a top-down image. The first computing device 10A obtains a principal axis of this feature point group, obtains the orientation of the normal of the walking surface as a tilt, and calculates an angle between the principal axis of the feature points and the normal of the walking surface. The first computing device 10A then creates a rotation matrix for aligning the angles of the two axes. Then, by applying the rotation matrix to all feature points of the feature point group to convert their positions, the first computing device 10A can correct the tilt of the feature points position. The first computing device 10A can estimate the body weight of the livestock using the corrected feature point group CFPC including corrected feature points CFP1 and the like, that has been corrected in this manner, whereby the estimated body weight corresponds to a walking surface corrected to a plane, and the accuracy of weight estimation is improved.

Lastly, the generation of a shipping plan using the weight distribution of any group of pigs, output by above-described pig weight estimation function and pig head counting function will be described. By using a pig weight-based sorting system according to the present disclosure, which assists in the shipping plan of pigs, the generation of a concrete shipping plan can also be automated using a computing device.

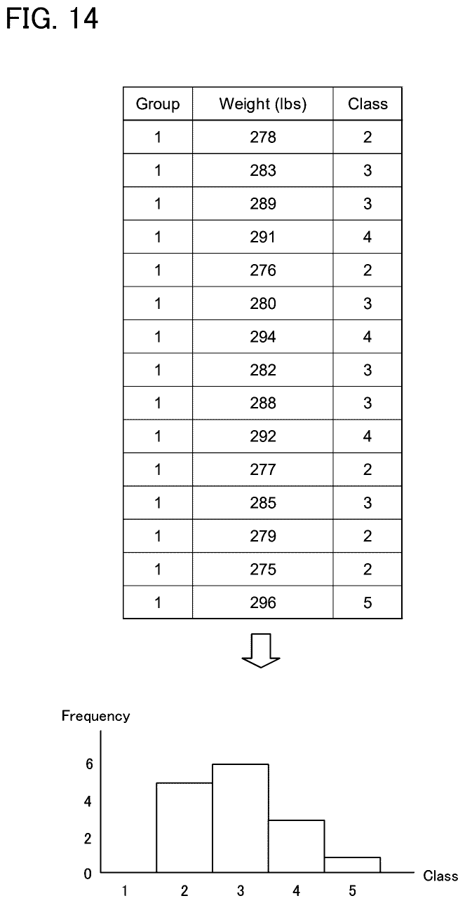

FIG. 14 shows an example of the weights and head counts of a group of pigs classified into weight-classes, output using the system of the present disclosure. FIG. 14 shows, for example, the weights, assigned classes, and their distribution for 15 pigs in an arbitrary group 1 composed of a plurality of pigs.

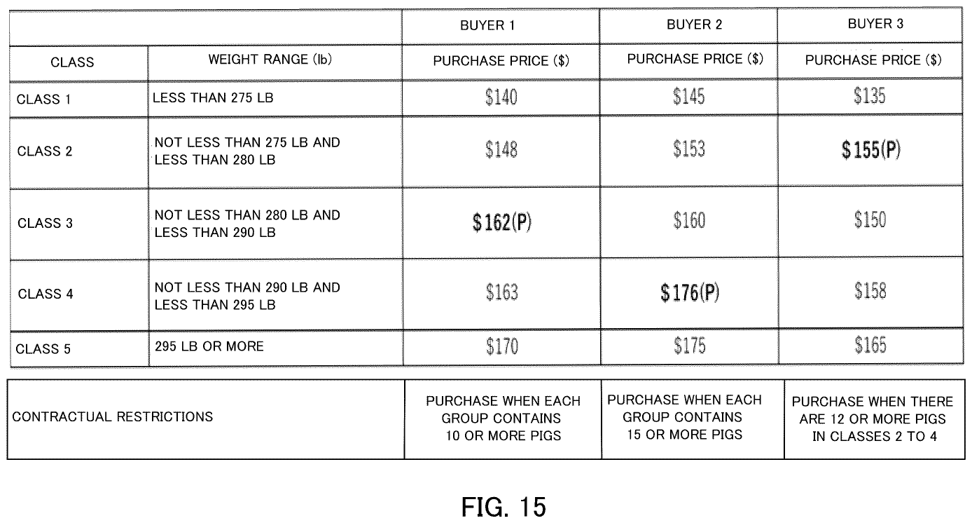

FIG. 15 is an example of purchase prices for pigs in each weight class, which are determined in advance on the basis of contracts with packers, for example. In this figure, buyers 1 to 3 represent, for example, packers. Each buyer offers different purchase prices for each weight class. Classes with premium prices are also provided. For example, buyer 1 sets a premium price for class 3, buyer 2 sets a premium price for class 4, and buyer 3 sets a premium price for class 2. Each buyer may also provide purchase-related restrictions in their contract, and such restrictions can be stored as data. For example, according to the contract, buyer 1 purchases pigs when each group contains 10 or more pigs, buyer 2 purchases pigs when each group contains 15 or more pigs, and buyer 3 purchases only when there are 12 or more pigs in classes 2 to 4. These types of data may be stored in the storage of one or more computing devices.

By having the computing device process these pieces of data, an optimal shipping plan can be generated. One or more processors of one or more computing devices can calculate which groups of livestock should be sold to which buyers in order to maximize revenue, thereby generating the optimal shipping plan. At this time, the weight distribution of each group and the contractual restrictions are taken into consideration. For example, in group 3 shown in FIG. 14, there are nine pigs belonging to classes 2 to 4. Therefore, it is not possible to ship the pigs in a manner that satisfies buyer 3's contractual requirement of “Ship 12 or more pigs belonging to classes 2 to 4”. An optimal shipping plan is generated by calculating how to allocate the number of pigs in each class among the buyers while satisfying the contractual terms (i.e., contractual restrictions) with each buyer. In this process, the prices for each weight class, including premium prices, can also be referenced.

Accordingly, through information processing by the computing device, the processor receives data including: estimated weight data of all individuals and the number of pigs belonging to a plurality of pig groups, provided by a weight estimation device that estimates, using images in a non-contact manner, the body weights of pigs belonging to a plurality of pig groups raised on the farm; the number of pigs each of the plurality of packers is to purchase, as predetermined in contractual condition data provided by a database; and purchase price data corresponding to the pigs' body weights, presented by the plurality of packers (including premium price data for pigs within a specific weight range). The processor calculates, for each of the plurality of packers, the following: potential sales forecasts for each packer if the sellable pigs in any given pig group are sold on the basis of the purchase price data (including premium price data for pigs within a specific weight range). The processor compares, for any given pig group, the potential pig sales revenues to the plurality of packers on the basis of the number of sellable pigs and the potential sales forecast. As a result of the comparison, the processor can optimize a shipping plan by selecting a packer that maximizes pig sales revenue when any given pig group is sold at the timing of the comparison and creating a shipping plan for any given pig group to the selected packer, thereby optimizing a shipping plan of any pig group composed of a plurality of pigs from the farm to the plurality of packers.

In some embodiments of the present disclosure and in other embodiments, one or more of the following features may be included by optional selection.

In some embodiments, a shippable livestock sorting system includes: a path along which a livestock animal moves in a single direction; one or more cameras that captures the livestock animal from above the path; one or more computing devices that includes one or more processors; and one or more computer-readable storage media that stores instructions. When the instructions are executed by the one or more processors, the one or more processors is caused to perform multiple operations. The multiple operations include: estimating body weight of the livestock animal based on the image captured by the camera; outputting the estimated weight information of the livestock animal; and using weight class information stored in a storage device and sortable into three or more classes according to the body weight, determining and outputting the weight class information corresponding to the estimated weight information of the livestock animal. The system further includes a display device that displays the weight class information of the livestock animal according to the weight class information, or a marking device that applies, with paint, a physical mark relating to the weight class information onto the body surface of the livestock animal according to the weight class information.

In some embodiments, the path further includes a temporary guidance structure that is provisionally installed to form one single-animal path or a plurality of single-animal paths arranged in parallel, each allowing only one livestock animal to pass through at a time.

In some embodiments, the indication related to the livestock animal's weight class information according to the weight class information is a light-emitting display in a color corresponding to the weight class information, or the marking related to the livestock animal's weight class information applied to the body surface of the livestock animal according to the weight class information is an ink coating in a color corresponding to the weight class information, and all of the colors corresponding to the weight class information are colors that cannot be visually recognized by the livestock animal.

Some embodiments further include an ascending slope provided at an entrance of the single-animal path and a descending slope provided at an exit of the single path.

In some embodiments, a flat portion is formed between the ascending slope and the descending slope.

In some embodiments, a first computing device is an edge computer and is equipped with at least one of a processing device such as the graphics processing unit (GPU), tensor processing unit (TPU), or neural processing unit (NPU), and that has a predetermined or greater image processing capability and video memory capacity, thereby enabling image analysis processing to be performed locally without borrowing computational resources from other computing devices via a network.

In some embodiments, the camera is a camera capable of acquiring distance images, and when outputting the estimated weight of the livestock animal using the distance images captured by the camera, the processor estimates a tilt of the walking surface of the livestock animal using at least four or more tilt detection points of the walking surface of the livestock animal acquired from the distance images, and outputs the estimated weight of the livestock animal corrected using the estimated tilt.

In some embodiments, a first computing device or a second computing device includes a function for operating an operation screen via a touch panel, and by touch and swipe operations, an analysis area that limits the image used for livestock weight estimation can be designated.

In some embodiments, the computing device includes a counting function for counting livestock that pass through a region of interest set within the analysis area. In some embodiments, the computing device can count livestock using the pig's mask centroid generated using depth information obtained from a stereo camera. When the pig's mask centroid has height information at or above a predetermined height, counting of pigs is performed.

In some embodiments, the computing device can function as a livestock counting device and output the number of livestock in any group.

In some embodiments, a method implemented by a computing device including one or more processors for optimizing a shipping plan of any pig group, composed of a plurality of pigs, from a farm to a plurality of packers, the method including the following steps: receiving, by the processor, data including: estimated weight data of all individuals and the number of pigs belonging to a plurality of pig groups, provided by a weight estimation device that estimates, using images in a non-contact manner, the body weights of pigs belonging to a plurality of pig groups raised on the farm; the number of pigs each of the plurality of packers is to purchase, as predetermined in contractual condition data provided by a database; and purchase price data corresponding to the pigs' body weights, presented by the plurality of packers (including premium price data for pigs within a specific weight range); calculating, by the processor, for each of the plurality of packers, the following: potential sales forecasts for each packer if the sellable pigs in the given pig group are sold on the basis of the purchase price data (including premium price data for pigs within a specific weight range); and comparing, by the processor, for the given pig group, the potential pig sales revenues to the plurality of packers on the basis of the number of sellable pigs and the potential sales forecast; and selecting, by the processor, as a result of the comparison, a packer that maximizes pig sales revenue when the given pig group is sold at the timing of the comparison, and creating a shipping plan for the given pig group to the selected packer.

Although several embodiments have been described and illustrated in this specification, various other means and/or structures may be employed to perform the functions described herein and/or to achieve one or more of the results and/or advantages disclosed herein, and each such variation and/or modification is considered to be within the scope of the embodiments described in this specification. More generally, all parameters, dimensions, materials, and configurations described in this specification are exemplary, and the actual parameters, dimensions, materials, and/or configurations will depend on the particular one or more applications in which these teachings are employed. Those skilled in the art will recognize and be able to verify numerous equivalents to the specific embodiments described herein simply by using routine experimentation. Accordingly, the foregoing embodiments are presented by way of example only, and it should be understood that embodiments may be practiced otherwise than specifically described herein, within the scope of the appended claims and their equivalents. The embodiments of the present disclosure relate to the individual features, systems, articles, materials, kits, and/or methods described in this specification. In addition, any combination of two or more of such features, systems, articles, materials, kits, and/or methods is also within the scope of the present disclosure, provided that the combination of such features, systems, articles, materials, kits, and/or methods is not mutually inconsistent.

What is claimed is:

1. A livestock weight estimation method comprising:
capturing, with one or more cameras, a group of livestock moving through a path from above the path;
estimating, by one or more computing devices that include one or more processors, body weight of a livestock animal included in an image captured by the camera,
identifying, by the one or more computing devices, the livestock animal included in the image captured by the camera;
counting, by the one or more computing devices, the number of livestock included in the group of livestock by incrementing the count of livestock when the identified livestock animal passes through a region of interest; and
generating and outputting, by the one or more computing devices, aggregate information based on the estimated body weight and the number of livestock, the aggregate information being used to create a shipping plan for the group of livestock.

2. The method according to claim 1, wherein the one or more computing devices simultaneously estimate the body weights of a plurality of livestock included in the image captured by the camera.

3. The method according to claim 1, wherein, among livestock animals included in the image captured by the camera, the one or more computing devices estimate only the body weight of the livestock animal that is included within a pre-designated analysis area.

4. The method according to claim 1 further comprising:
providing, by the one or more computing devices, a representative value by statistically processing the estimated body weight.

5. The method according to claim 1 further comprising:
estimating, by the one or more computing devices, a tilt of a walking surface of the livestock animal, and correcting the estimated body weight of the livestock animal on the basis of the tilt, wherein the one or more computing devices generate the aggregate information using the corrected body weight and the number of livestock.

6. A livestock weight estimation system comprising:
one or more cameras that capture a group of livestock moving through a path from above the path;
one or more computing devices that include one or more processors; and
one or more computer-readable storage media that store instructions, wherein the one or more processors execute a process by executing the instructions, the process includes:
estimating body weight of a livestock animal included in an image captured by the camera;
identifying the livestock animal included in the image taken by the camera;
counting the number of livestock included in the group of livestock by incrementing the count of livestock when the identified livestock animal passes through a region of interest; and
generating and outputting aggregate information based on the estimated body weight and the number of livestock, the aggregate information being used to create a shipping plan for the group of livestock.

7. The system according to claim 6, wherein the one or more processors simultaneously estimate, in the process, the body weights of a plurality of livestock animals included in the image captured by the camera.

8. The system according to claim 6, wherein, among livestock animals included in the image captures by the camera, the one or more processors estimate, in the process, only the body weight of the livestock animal that is included within a pre-designated analysis area.

9. The system according to claim 6, wherein the process further includes providing a representative value by statistically processing the estimated body weight.

10. The system according to claim 6, wherein the process further includes estimating a tilt of a walking surface of the livestock animal, and correcting the estimated body weight of the livestock animal on the basis of the tilt, wherein the one or more processors generate, in the process, the aggregate information using the corrected body weight and the number of livestock.
